(19) United States
(12) Patent Application Publication
(10) Pub. No.: US 2015/0104606 A1
(43) Pub. Date: Apr. 16, 2015

(54) TRANSLUCENT COMPOSITE STONE PANELS

(71) Applicant: ForzaStone LLC, Mesa, AZ (US)

(72) Inventor: Curtis Ray, Mesa, AZ (US)

(21) Appl. No.: 14/574,130

(22) Filed: Dec. 17, 2014

Related U.S. Application Data
(63) Continuation-in-part of application No. 13/972,799, filed on Aug. 21, 2013.
(60) Provisional application No. 61/725,104, filed on Nov. 12, 2012.

(51) Int. Cl. E04C 2/54; B28D 1/02

(52) U.S. Cl. CPC E04C 2/543; B28D 1/02
USPC 428/116; 29/897.32

(57) ABSTRACT

A translucent composite stone panel can comprise a translucent stone slab of onyx or travertine. The composite stone panel can comprise a length greater than or equal to 1.2 m, a width greater than or equal to 0.6 m, and a thickness in a range of 0.2-1.5 cm. The translucent stone slab can further comprise a length greater than or equal to 2.4 m and a width greater than or equal to 1.2 m. The translucent composite stone panel can further comprise a translucent honeycomb panel backer comprising a length greater than or equal to 1.2 m, a width greater than or equal to 0.6 m, a thickness in a range of 0.2-1.5 cm that is coupled to the translucent stone slab. The translucent honeycomb panel backer can further comprises a length greater than or equal to 2.4 m and a width greater than or equal to 1.2 m.

### RELATED APPLICATIONS

This application claims priority to, and is a continuation-in-part application of, U.S. patent application Ser. No. 13/972,799, titled “Composite Stone Panels,” filed Aug. 21, 2013, which claims the benefit of U.S. Provisional Application No. 61/725,104, filed Nov. 12, 2012, the disclosures of which are incorporated in their entireties by this reference.

### TECHNICAL FIELD

The present disclosure relates to the field of building materials including decorative stone finishes for interior and exterior uses.

### BACKGROUND

Stone is a popular building material that is often used for its structural and aesthetic qualities. When selecting pieces of stone for use in building applications, a thickness of stone is selected to ensure structural integrity and prevent cracking and breaking of the stone. However, in many applications a thickness of the stone pieces selected for panels, slabs, or tiles was large enough that the stone was expensive, heavy, difficult to transport and install, and limited the overall dimensions or size of the stone pieces.

More recently, the thicknesses of stone pieces has been reduced in an effort to reduce material, cost, and weight. In some instances, additional materials have been placed on a surface of the stone to increase strength and compensate for the reduction in stone thickness. For example, granite countertops sometimes include a fiberglass mesh that is applied to an underside or unexposed surface of the countertop to increase tensile strength and reduce bowing. Additionally, in applications using stone that is particularly susceptible to warping, such as Carrara Marble, more robust reinforcement has been used to reduce the undesirable warping and bowing that causes fissures or cracks to form in a surface of the stone. More robust reinforcement for stone has included a metal backer that includes an aluminum honeycomb sandwiched between two aluminum plates. Similarly, some tile applications, such as small ceramic tiles (with dimensions of approximately 12×12 inches (in.) to approximately 18×18 in.) have added a porcelain backer to increase tile strength.

Known reinforcement methods have not allowed for stone panels with thickness less than 10 millimeters (mm) to have areas with dimensions greater than 2.4 meters (m) (or 8 feet (ft.)) by 1.2 m (or 4 ft.).

### SUMMARY

A translucent composite stone panel can comprise a translucent stone slab of onyx or travertine comprising a length greater than or equal to 1.2 m, a width greater than or equal to 0.6 m, and a thickness in a range of 0.2-1.5 centimeters (cm). A translucent honeycomb panel backer can also comprise a length greater than or equal to 1.2 m, a width greater than or equal to 0.6 m, and a thickness in a range of 0.2-1.5 cm that is coupled to the translucent stone slab.

The translucent composite stone panel can further comprise the translucent stone slab of onyx or travertine comprising a length greater than or equal to 2.4 m and a width greater than or equal to 1.2 m, and the translucent honeycomb panel backer comprising a length greater than or equal to 2.4 m and a width greater than or equal to 1.2 m. The translucent composite stone panel can further comprise a lighting unit coupled to the translucent panel backer to illuminate the translucent stone slab. The translucent honeycomb panel backer can further comprise a fiberglass or plastic translucent core layer comprising structural members of the core layer. The first and second fiberglass or plastic translucent interface layers can be disposed on opposing sides of the translucent core layer, wherein the first and second fiberglass or plastic translucent interface layers comprise a thickness in a range of 0.2-0.3 mm. A plurality of the translucent composite stone panels can be formed as an architectural feature, the architectural feature further comprising a translucent frame coupled to the translucent panel backers and disposed opposite the translucent stone slabs without a track support and without covering any portion of the translucent stone slabs. The translucent composite stone panel can comprise a translucent frame comprising support members made of acrylic-glass or polyvinylchloride (PVC). The translucent composite stone panel can be formed without a glass backer and without a solid PVC backer.

In another aspect, a translucent composite stone panel can comprise a translucent stone slab of onyx, travertine, or marble comprising a length greater than or equal to 1.2 m and a width greater than or equal to 0.6 m. A translucent honeycomb panel backer can be coupled to the translucent stone slab. The composite stone panel can comprise a thickness in a range of 0.2-4.0 cm.

The translucent composite stone panel can further comprise the translucent stone slab of onyx, travertine, or marble comprising a length greater than or equal to 2.4 m and a width greater than or equal to 1.2 m. The translucent stone slab can comprise a thickness in a range of 0.2-2.0 cm. The translucent honeycomb panel backer can comprise a thickness in a range of 0.2-2.0 cm, wherein the translucent honeycomb panel backer further comprises a fiberglass or plastic translucent core layer comprising structural members of the core layer, and first and second fiberglass or plastic translucent interface layers disposed on opposing sides of the translucent core layer, wherein the first and second fiberglass or plastic translucent interface layers comprise a thickness in a range of 0.2-0.3 mm. The translucent composite stone panel can further comprise a lighting unit coupled to the translucent panel backer to illuminate the translucent stone slab. A plurality of the translucent composite stone panels can be formed as an architectural feature, the architectural feature further comprising a translucent frame coupled to the translucent panel backers and disposed opposite the translucent stone slabs without a track support and without covering any portion of the translucent stone slabs exposed with respect to the translucent panel backer. The translucent composite stone panel can comprise a translucent frame that comprises support members made of acrylic-glass or PVC. The translucent composite stone panel can formed without a glass backer and without a solid PVC backer.

In yet another aspect, a method of making a translucent composite stone panel can comprise providing a translucent stone slab of onyx or travertine comprising a length greater than or equal to 1.2 m and a width greater than or equal to 0.6 m, attaching first and second translucent panel backers to first and second opposing surfaces of the translucent stone slab, and forming first and second translucent composite stone panels by cutting the translucent stone slab between the first and second translucent panel backers.

The method of making the translucent composite stone panel can further comprise providing the translucent stone slab with a length greater than 2.4 m, a width greater than 1.2 m, and thickness in a range of 0.2-1.5 cm, and forming the first and second translucent composite stone panels comprising a thickness in a range of 0.4-3.0 cm. Forming each of the first and second translucent panel backers can further comprise providing a fiberglass or plastic translucent core layer comprising structural members of the core layer, and coupling first and second fiberglass or plastic translucent interface layers on opposing sides of the translucent core layer, wherein the first and second fiberglass or plastic translucent interface layers comprise a thickness in a range of 0.2-0.3 mm. The method can further comprise forming an architectural feature comprising forming a translucent frame comprising support members made of acrylic-glass or PVC, coupling the translucent panel backer to the translucent frame with the translucent panel backer disposed opposite the translucent stone slab without a track support and without covering any portion of the translucent stone slab exposed from the translucent panel backer, and forming the translucent composite stone panel without a glass backer and without a solid PVC backer. The translucent stone slab can be illuminated with a lighting unit coupled to the translucent panel backer. A method of installing the first translucent composite stone panel can further comprise transporting the first translucent composite stone panel to an installation site, cutting the translucent stone slab and the translucent panel backer of the first translucent composite stone panel at a same time to change a dimension of the first translucent composite stone panel to conform to a dimension of the installation site.

### BRIEF DESCRIPTION OF THE DRAWINGS

FIGS. 1A-1B illustrate front and side cross-sectional views of stone slabs being cut from a stone block.

FIG. 2 illustrates a plurality of panel backers and dimpling slipsheets disposed within a press.

FIG. 3 illustrates a stone slab with panel backers disposed on opposing sides of the stone slab.

FIG. 4 illustrates an embodiment of a completed composite stone panel comprising a single panel backer.

FIG. 5 illustrates an embodiment of a completed composite stone panel comprising a single panel backer.

FIG. 6 illustrates a method of forming a composite stone panel.

FIG. 7 illustrates an embodiment of a completed translucent composite stone panel.

FIGS. 8A and 8B illustrate architectural features formed of composite stone panels.

### DETAILED DESCRIPTION

Embodiments in the disclosure present devices, methods, and systems to improve the application of stone as a decorative finish using large composite stone panels. In the following description, numerous specific details are set forth, such as specific configurations, sizes, compositions, and processes, in order to provide a thorough understanding of the disclosure. In other instances, well-known aspects have not been described in particular detail in order to not unnecessarily obscure the disclosure. Furthermore, it is to be understood that the various embodiments shown in the FIGS. are illustrative representations and are not necessarily drawn to scale. Similarly, the proportions and relative sizes of various layers illustrated in the FIGS. are also not to scale and can vary according to different embodiments.

The terms “over,” “under,” and “between,” as used herein, refer to relative positions of one feature with respect to other features. One feature deposited or disposed above, below, over, or under another feature may be directly in contact with the other feature or may have one or more intervening features. One feature deposited or disposed between features may be directly in contact with the features or may have one or more intervening features. A first feature “on” a second feature may be directly in contact with the second feature or may have one or more intervening features.

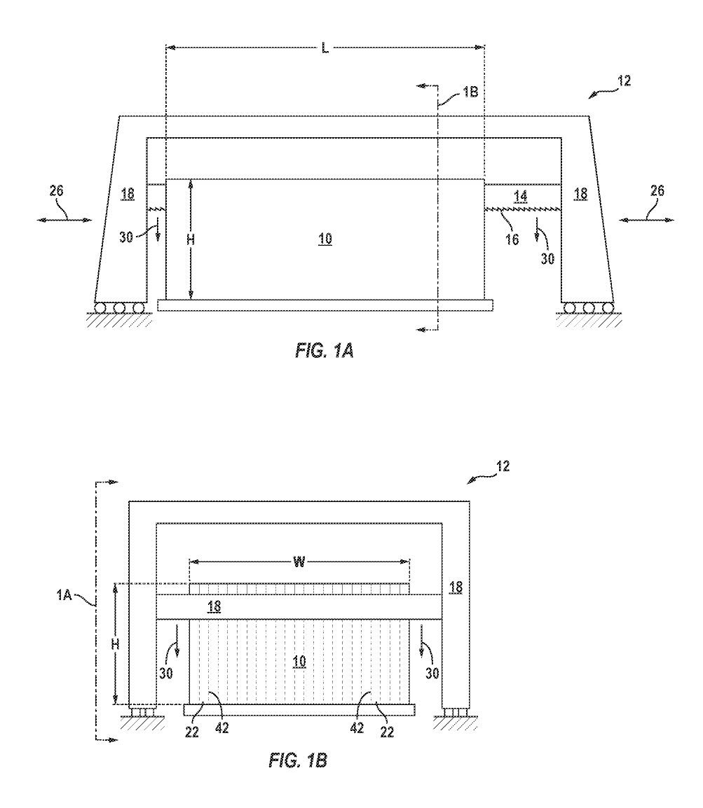

FIGS. 1A and 1B show elevational cross sectional views of a stone block 10 being cut by a stone-cutting saw, gang saw, or block cutters 12. FIG. 1A shows a cross-sectional view taken transverse, or perpendicular, to width W of stone block 10 (as shown by section line 1A in FIG. 1B). Similarly, FIG. 1B shows a cross-sectional view taken transverse, or perpendicular, to length L of stone block 10, (as shown by section line 1B in FIG. 1A), such that FIGS. 1A and 1B show views that are perpendicular or rotated 90 degrees with respect to each other.

Stone block 10 can include any stone that is desirable for construction applications including igneous, metamorphic, and sedimentary stones such as marble, granite, travertine, or any other stone. Stone block 10 can include a height (H) in a range of approximately 0.6-1.8 m (or 2-6 feet), a length (L) in a range of approximately 1.2-3.7 m (or 4-12 feet), and a width (W) in a range of approximately 5-150 cm (or 2-60 inches (in.) or more) to produce stone slabs with a lesser thickness and a greater area than was previously possible and practical in the art.

Stone cutting saw 12 can include one or more saw blades 14 and a blade driving element or frame 18. By employing a plurality of saw blades 14 attached to frame 18, block 10 can be simultaneously cut into a number of stone slabs or panels 22. Saw blades 14 can include a cutting edge or serrations 16 formed along an edge of the saw blades. Saw blades 14 can be made of one or more materials, such as metal with an abrasive cutting edge or diamond tipped serrations. Saw blades 14 can include first and second opposing ends attached to opposing points of frame 18. For example, in an embodiment, frame 18 comprises a u-shaped portion that alternately moves in opposing directions along a fixed line such that saw blades 14 can be drawn back and forth across block 10 with cutting edge 16 in contact with block 10 to cut or remove material from the block.

As shown in FIG. 1B, one or more stone slabs or panels 22 can be cut from stone block 10 as saw blades 14 are moved back and forth across stone block 10 in a direction 26 (see FIG. 1A) that is substantially parallel with a length L of block 10 and perpendicular to a width W of block 10. Additionally, as saw blades 14 remove material from block 10, saw blades 14 can also move in a direction 30 that extends through height H of stone block 10 to form stone slabs 22. Saw blades 14 provide planar cuts along projected cutting lines or segmentation lines 42 to form stone slabs 22.

Stone slab 22 can be cut from stone block 10 after receiving shipment of the stone block from a quarry. Exposed or sawn surfaces of stone slabs 22 can be rough and non-planar after cutting. In an embodiment, stone slabs 22 comprise a thickness greater than or equal to about 1.7 cm, which allows for processing and the formation of composite stone panels as described below. In applications in which smoother, more planar exposed surfaces are desired, stone slabs 22 can be further planarized and smoothed, thereby forming stone slabs 22 with a substantially uniform thickness. Exposed surfaces of stone slab 22 can be planarized by grinding, polishing, or other suitable process or combination of processes. In an embodiment, stone slabs 22 can be placed in a gauging machine to planarize the exposed surfaces. Different tolerances for a thickness and surface planarity of stone slabs 22 can be set depending on the final application or end use of the stone slab.

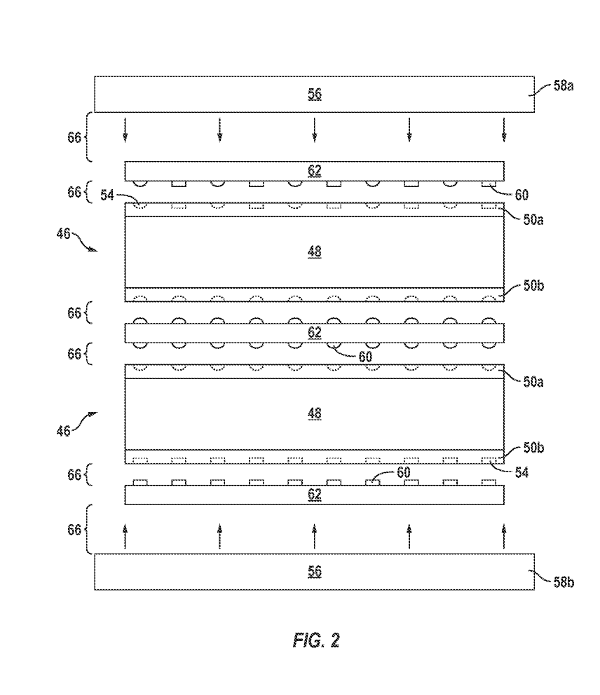

FIG. 2 shows an elevational cross sectional view of portions of a plurality of panel backers 46, which are a structural elements that can be attached to stone slabs 22 to provide additional structural support. Panel backers 46 can be composite panels comprising one or more layers that, taken together, form a thicker structural support than what has been conventionally used in art. In an embodiment, panel backers 46 can comprise three layers, a non-metallic core material layer 48 disposed between first and second metallic interface layers 50a and 50b. In an embodiment, panel backers 46 can be purchased as integral, pre-formed panels. Panels comprising a non-metallic core layer and opposing metallic interface layers can be available for purchase as panels that are sold for use as exterior finishes for structures such as commercial buildings used for office or retail space. For example, Feiteng Aluminum Composite Panel Co., Ltd and Multipaneluk, Ltd are examples of companies that currently provide composite aluminum panels. However, such panels for use as exterior surface finishes typically include a thickness in a range of about 2.0-3.0 mm (or 80-120 mils) when used as building wraps, which is less than a thickness used for composite stone panels having an size as described above with respect to FIGS. 1A and 1B.

Core material layer 48 can be a non-metallic core material such as plastic, fiberglass, resin, polymer, or other suitable material comprising an optional fibrous material embedded within the core material such as fibers, strands, woven material, or other material in other suitable forms. Core material layer 48 can be a solid core material that is formed of one or more uniform materials or layers without openings or voids, e.g. not a honeycomb material comprising distinct structural members and sectioning off separate spaces as shown and described with respect to FIG. 5. Forming core material layer 48 of a solid core material can include, by way of non-limiting example, forming the core material layer 48 of a thermoplastic comprising any suitable polymer, such as polyolefins (PO), polyethylene (PE), low-density PE, high-density PE, polypropylene (PP), vinyl chlorides such as polyvinyl chloride (PVC), polyester (polytheylene terephthalate), or other suitable material, any of which can comprise an optional fiber material for structural reinforcement. As such, the core material can also be formed as an expanded or foam material such as expanded polyolefin (EPO), expanded polyethylene (EPE), expanded polypropylene (EPP), or other suitable material. The expanded or foam material forming core material layer 48 can comprise some small spaces as part of the solid layer or layers that are distinct from the types of openings or voids that would be formed as part of a non-solid honeycomb material.

The core material layer 48 can comprise a thickness, or minimum thickness, in a range of about 3.75 mm-6.00 mm. In some embodiments, a minimum thickness of about 4 mm of PE for core material layer 48 can be desirable because in applications where a thickness of about 3 mm of PE was used the panel backers were prone to breaking, which in turn would crack the stone slabs to which the panel backers were attached. The core material layer 48 can also include a thickness less than 14.58 mm, less than 14.4 mm, less than 9.58 mm, less than 9.4 mm, less than 4.58 mm, or less than 4.4 mm. In some embodiment the core material layer 48 can comprise a minimum thickness of 3.0 mm, and as such the core material layer can comprise a thickness in a range of 3.0-14.58 mm, 3.0-14.4 mm, 3.0-9.58 mm, 3.0-9.4 mm, 3.0-4.58 mm, or 3.0-4.4 mm. As a non-limiting example, a coefficient of thermal expansion (CTE) for low-density PE can be approximately 200×10⁻⁶ m/m K.

Alternatively, core material layer 48 can also be made using a high-density PE, in which case a thickness of the high-density PE can be similar, or equal, to a thickness of the low-density PE. High-density PE comprises a tensile strength similar to a tensile strength of low-density PE and can include a tensile yield strength in a range of about 26-33 megapascals (MPa) and an ultimate tensile strength of about 37 MPa. However, high-density PE can have a CTE in a range of about 20-100×10⁻⁶ m/m K, and therefore undergoes less expansion and contraction per unit of temperature change than does low-density PE. Accordingly, panel backers 46 made with high-density PE can experience less bowing and warping than panel backers made using low-density PE, and as such can be used for applications in which bowing would be especially problematic, such as in applications where the panels might be exposed to large changes in temperature. Use of high-density PE as part of panel backers 46 can also be beneficial because high-density PE is fire resistant and can decrease a spread of fire, thereby increasing safety and broadening a market for the product to include commercial buildings and locals with strict fire codes.

First interface layer 50a and second interface layers 50b are disposed on opposing sides of core material layer 48 to form a composite panel backer 46. In an embodiment, panel backer 46 is a partially metallic composite panel in which interface layers 50a and 50b are metallic and can be made of any suitable metal such as, without limitation, steel, iron, copper, aluminum, or alloys thereof. In a particular non-limiting embodiment, interface layers 50a and 50b comprise aluminum interface layers including a thickness in a range of about 0.21-0.30 mm (or about 8-12 mils). A similar range of thicknesses can be used for other types of metals. While greater thicknesses of metal can be used for interface layers 50a and 50b, increasing a thickness of metal interface layers 50a and 50b also increases a weight of panel backer 46, which can make the panel backer more difficult to move and install as well as increase a cost of material for the panel backer, each of which is undesirable. Aluminum interface layers 50a and 50b include a CTE of about 28, and can be oxidized, anodized, coated, or otherwise treated to increase durability and material life of the interface layers, especially for exterior or outdoor applications.

Use of panel backers comprising core material layer 48 sandwiched or interleaved between two opposing metal interface layers 50a and 50b provides a number of advantages. First, plastic core materials, such as PE, generally have very little tensile strength. By using higher tensile strength interface layers, such as metals, to attach to core material layer 48, an overall tensile strength of panel backer 46 increases, which in turn increases a strength of a composite stone panel as described in greater detail below. Using first and second interface layers 50a and 50b attached to opposing sides of core material layer 48 creates panels with greater strength than similar panels that use only a single interface layer. For example, a modified panel backer using only a single aluminum interface layer comprising a thickness in a range of approximately 0.2-0.3 mm coupled to a PE core layer comprising a thickness of approximately 6 mm was not suitable because the modified panel backers were prone to breaking, which would in turn crack the stone slabs to which they were attached. Thus, the use of two metal interface layers, such as interface layers 50a and 50b, drastically reduces a number of incidents of the stone cracking due to thermal cycling and CTE mismatches.

In order to objectively demonstrate performance of composite stone panels 80, an independent lab, Massachusetts Materials Research, Inc. (MMR), was contracted to measure the yield load force following ASTM C880 test method. The yield load forces were measured for both 3-layer composites and 4-layer composites, and were compared to each other. Details of the 3-layer composites and 4-layer composites are presented in greater detail below. Ten specimens of each sample size of 10.16 cm (4 in.) wide, 38.2 cm (15 in.) long, and 0.73 cm (0.3 in.) thick were tested under dry conditions. The fatigue tests were performed using an MTS closed loop servo hydraulic test system.

Details of the 3-layer composites and 4-layer composites were such that the 4-layer composites include a layer of a stone comprising a thickness less than 25 mm; a first aluminum interface layer comprises a thickness in a range of 0.21-3.0 mm and is coupled to the layer of stone and coupled to a first surface of a core material layer; the core material comprises a thickness of polyethylene in a range of 3.75-6.0 mm; and a second aluminum interface layer comprises a thickness in a range of 0.21-3.0 mm that is coupled to a second surface of the core material layer opposite the first surface. The 3-layer composite includes a layer of a stone comprising a thickness less than 25 mm; an aluminum interface layer comprising a thickness in a range of 0.21-3.0 mm coupled to, and between, the layer of stone and a first surface of a core material layer; the core material comprises a thickness of polyethylene in a range of 3.75-6.0 mm. In the 3-layer composite, a second aluminum interface layer is omitted. The stone layer for both the 3-layer composite and the 4-layer composite were tested as either marble or travertine. The tests were conducted for both the 3-layer and 4-layer composites in two positions, i.e., with the stone face-up and the stone face-down. Table 1, included below, shows unexpected improvement between the 3-layer composite and the 4-layer composite design that is statistically significant, providing a percent strength gain for average yield load force (lbs) in a range of 38-415%. Table 1 also shows the average yield load force, or force at which the stone of the composite stone panel began cracking.

TABLE 1
Average Yield Load Force (lbs)

| | | | | Marble | Travertine |
|---|---|---|---|---|---|
| | Composite | | | Strength | Strength |
| Oreintation | Layers | Marble | Travertine | Gain | Gain |
| Stone Face Down | 3 | 41.6 | 8.2 | 38% | 415% |
| | 4 | 57.4 | 42.2 | | |
| Stone Face Up | 3 | 105 | 113.4 | 83% | 88% |
| | 4 | 191.8 | 213.4 | | |

Similarly, the results presented in Table 2, included below, also show that adding a second aluminum interface layer comprising a thickness in a range of 0.21-6.0 mm to a second side of the polyethylene core material, opposite the first side, resulted in an unpredicted and unexpected change in the yield load strength of the 4-layer composite with respect to the 3-layer composite. The yield load strength gains, i.e. the gains measured for the force at which the stone of the composite stone panel completely failed, are included in Table 2 and are statistically significant, varying from a 23% to 416% increase.

TABLE 2
Average Maximum Load Force (lbs)

| | | | | Marble | Travertine |
|---|---|---|---|---|---|
| | Composite | | | Strength | Strength |
| Oreintation | Layers | Marble | Travertine | Gain | Gain |
| Stone Face Down | 3 | 108.8 | 17.2 | 23% | 416% |
| | 4 | 134.2 | 88.8 | | |
| Stone Face Up | 3 | 237.8 | 259.2 | 60% | 56% |
| | 4 | 379.6 | 404.2 | | |

Additionally, the formation of panel backers 46 comprising deformable or malleable interface layers 50a and 50b, allows for the formation of dimples 54 by texturing, roughening, or dimpling of panel backers 46 or interface layers 50a and 50b. Dimples 54 can be discrete indentations shaped as hemispheres, squares, rectangles, blocks, polygons, prisms, or any other geometric or organic shape or combination of shapes formed in a pattern, grid, or array across one or more surfaces of panel backers 46. Alternatively, dimples can be a continuous texture or pattern comprising ridges, channels, troughs, hatching, or other suitable marking that increases a surface area of an exposed surface of panel backers 46, such as interface layers 50a and 50b. In either case, dimples 54 can extend across an entirety of one or more surfaces of panel backers 46; or alternatively, can extend across only a portion of the one or more surfaces that is less than an the entirety.

The optional formation of dimples 54 can increase a surface area of the interface layers and improve subsequent bonding of surfaces of panel backers with adhesives and other materials or layers. As one non-limiting example, a surface area of one or more interface layers 50a or 50b can be approximately doubled. By increasing the surface area of the interface layers 50a or 50b, a greater quantity of adhesive can come in contact with the interface layers and form a stronger bond between the interface layers and other materials mounted to the interface layers. Materials mounted to the interface layers can include, without limitation, subsequently mounted stone slabs or a surface to which a completed composite stone panel will be mounted. Increasing a surface area of interface layers 50a and 50b by creating dimples 54 is a cost effective and time effective way for increasing a bonding surface area with a stone slab. The use of dimples 54 is more efficient than modifying a surface of the stone slab itself to increase surface area, such as by forming grooves in a back surface of the stone slab. Forming grooves or texturing a hard stone slab can require more time and cost than adding dimples 54 to deformable or malleable interface layers 50a and 50b.

Dimples 54 can be formed on panel backers 46 by physical or chemical processes such as pressing, stamping, punching, spraying, blasting, etching, imaging, radiating, or other suitable process. In an embodiment, dimples 54 are formed on one or more panel backers 46 by applying pressure with a press or hydraulic press 56. Press 56 can include first and second opposing plates 58a and 58b, between which an object to be pressed is placed. A number or protrusion 60 are used together with press 56 form dimples 54. Dimples 54 are formed in interface layers 50a and 50b as a material of the interface layers is deformed by protrusions 60, which are made of a material that is harder or less malleable than the material in which dimples 54 are formed. A size, shape, number, and location of protrusions 60 can be a substantial mirror image of the size, shape, number, and location of dimples 54. Protrusions 60 can be formed on one or more plates 58a and 58b of press 56, or alternatively, can be formed on, or as part of, slipsheets or dimpling sheets 62.

Slipsheets 62 are panels or sheets that can be disposed between plates 58 of press 56 and panel backers 46. Slipsheets 62 generally include an area that is greater than or equal to an area of panel backers 46. Slipsheets 62 can be formed with dimples 54 on one or more surfaces of the slipsheets and can be used in conjunction with press 56 for forming dimples 54 in panel backers 46. Protrusions can be formed on slipsheets 62 instead of, or in addition to, forming protrusions on one or more plates 58a and 58b of press 56. When slipsheets 62 are formed with protrusions 60, the slipsheets can comprise a single dimpled surface and an opposing planar surface or two opposing dimpled surfaces.

As shown in FIG. 2, a plurality of panel backers 46 can be disposed between opposing plates 58a and 58b of press 56 and can be interleaved with a plurality of and slipsheets 62. Accordingly, slipsheets 62 can be alternately disposed between panel backers 46, such that, as a non-limiting example, a first slipsheet is placed between plate 58a and a first panel backer 46, a second slipsheet 62 is placed between first and second panel backers 46, and a third slipsheet 62 is disposed between the second panel backer 46 and plate 58b. Thus, while FIG. 2 illustrates an embodiment with three slipsheets 62 and two panel backers 46, any number of panel backers 46 and slipsheets 62 can be disposed in press 56 at a same time. For example, a single panel backer 46 without any slipsheets 62 can be disposed between plates 58a and 58b, wherein plates 58a and 58b comprise protrusions 60. As plates 58a and 58b of press 56 are brought together the spaces 66 between plates 58a and 58b, slipsheets 62, and panel backers 46 is removed such that protrusions 60 are pressed into panel backers 46 and dimples 54 are made in the panel backers.

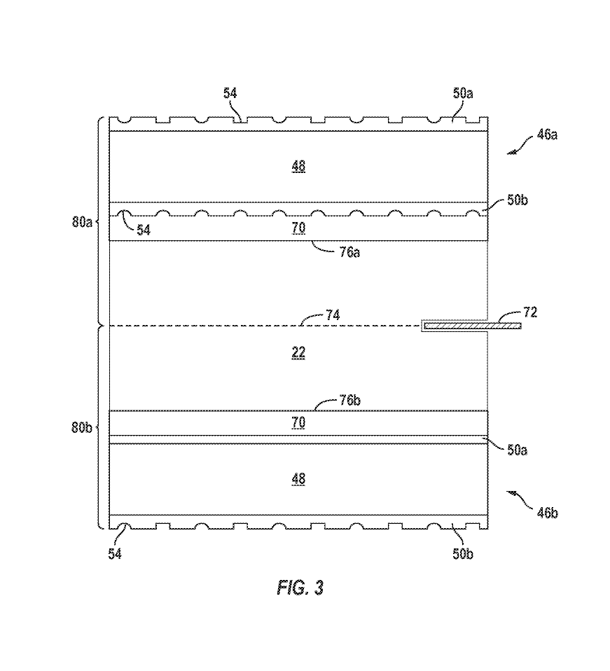

FIG. 3 shows a first panel backer 46a and a second panel backer 46b, similar to panel backers 46 shown in FIG. 2, attached to a stone slab 22 as discussed above with respect to FIGS. 1A and 1B. In an embodiment, a thickness of stone slab 22, that is a distance between opposing surfaces 76a and 76b of the stone slab 22, comprises greater than or equal to about 1.7 cm. Panel backers 46a and 46b are attached to stone slab 22 with adhesive or glue 70. A thickness of adhesive 70 can be in a range of 0.2 mm-1.5 mm. Adhesive 70 can be a one-stage or multi-stage adhesive that cures, dries, or chemically reacts to provide a permanent bond and physical connection between panel backers 46a and 46b, as well as stone slab 22. In an embodiment, adhesive 70 is an epoxy glue. FIG. 3 shows panel backers 46a and 46b attached with adhesive 70 to opposing sides of stone slab 22. Panel backers 46a and 46b can be attached to stone slab 22 at a same time or during a same processing step such that adhesive 70 is applied to, and cures or sets, on multiple and/or opposing surfaces of the stone slab at a same time. Alternatively, panel backers 46 can be attached to opposing sides of stone slab 22 at different times or during different processing steps.

When panel backers 46 are glued to stone slab 22, conditions of temperature, pressure, humidity, and time can be controlled to ensure a good bond between adhesive 70 and panel backers 46, as well as between adhesive 70 and stone slab 22. In an embodiment, adhesive 70 cures or dries while panel backers 46 and stone slab 22 are placed, under pressure, in a press similar to press 56 from FIG. 2. Panel backers 46 can be glued to stone slab 22 such that substantially an entirety of stone slab 22, or substantially an entirety of a surface 76a or 76b of stone slab 22, is covered by one or more panel backers. Alternatively, portions of stone slab 22 can remain exposed such that less than an entirety of surfaces 76a and 76b of stone slab 22 is covered by the one or more panel backers.

FIG. 3 further shows a saw blade or cutting tool 72 of a saw or splitting machine that is cutting stone slab 22 along segmentation line or projected cut line 74. Segmentation line 74 is disposed between outer surfaces 76a and 76b of stone slab 22. In an embodiment, segmentation line 74 can be disposed equidistantly between outer surfaces 76a and 76b, such that saw blade 72 cuts stone slab 22 into substantially equal thicknesses, for example, thicknesses in a range of approximately 0.2-1.5 cm, to form first and second composite stone panels 80a and 80b, respectively, comprising panel backers 46, adhesive 70, and stone slabs 22. Stone slab 22 can be gauged or calibrated to have a thickness in a range of 7.5-9.5 mm, and in some instances includes thickness of about 8.5 mm. In other embodiments the segmentation line 74 can be offset between outer surfaces 76a and 76b to form more than one stone slab 22 with differing thicknesses.

In an embodiment, stone slab 22 is cut along segmentation line 74 with saw blade 72, which can be configured as part of a vibrating bandsaw and can also comprise a circular or band-like shape. Saw blade 72 can further comprise a cutting edge or serrations along an edge of the blade, and be similar in shape to a shape of blades used in bandsaws. Saw blade 72 can be made of one or more materials, such as metal with an abrasive cutting edge or diamond tipped serrations. Saw blade 72 can oscillate or be driven rotationally around one or more blade driving elements (similar to a belt being driven by gears, wheels, or cogs) such that the movement of saw blade 72 relative to stone slab 22 will cut or remove material from the slab along segmentation line 74 to form first and second composite stone panels 80a and 80b.

Stone slab 22 attached to panel backers 46 can be moved relative to saw blade 72 by being placed on a conveyor, splitting conveyor, or table that can include a number of belts or rollers that rotate to drive stone slab 22 through a cutting path of saw blade 72 along segmentation line 74. By maintaining a surface of the conveyor substantially parallel, and at a substantially fixed distance, with respect to saw blade 72, stone slab 22 is segmented to form first and second composite stone panels 80a and 80b. A cutting speed or a speed of how quickly saw blade 72 travels along segmentation line 74 is controlled by the relative movement of saw blade 72 and stone slab 22 in a direction of segmentation line 74. A desired cutting speed and blade thickness of saw blade 72 is determined by a size and hardness of stone slab 22 and by an amount of material being removed from the stone slab by saw blade 72. In an embodiment, the cutting speed of stone slab 22 is in a range of approximately 0.211 mm/sec-0.635 mm/sec. A thickness of saw blade 72 can be in a range of 0.75-2.0 mm. As such, stone slab 22 can be segmented to form first and second composite stone panels 80a and 80b by using blade 72, which can be thinner and more delicate than standard blades, such as blade 14, that are used for cutting stone blocks 10. By accounting for a thickness of saw blades 72, cutting speed, stone hardness, and stone size, overheating is avoided during the cutting of stone slab 22. Water can also be used during the cutting of slabs 22 to reduce a risk or likelihood of overheating.

As a width and length of stone panel 22 increases, a length of saw blade 72 can also increase to provide a liner cutting portion of the saw blade that is long enough to provide a planar cut across the stone panel and along segmentation line 74. As a length of saw blade 72 increases, a resonance of saw blade 72 also increases. In order to avoid excess resonance of saw blade 72, a thickness of the saw blade is also increased. However, as a thickness of saw blade 72 increases, a larger portion of stone is removed along segmentation line 74 during formation of first and second composite stone panels 80a and 80b, which adds to waste by reducing an amount of usable material within stone slab 22. Accordingly, a point of diminishing returns is reached in which additional thickness of saw blade 72 reduces less resonance while removing more material from stone slab 22. While a thickness of saw blade 72 varies with cutting speed, stone hardness, and stone size, a thickness of saw blade 72 is typically in a range of 1.0-2.0 mm, which is thicker than the blade thickness conventionally used for cutting smaller stone panels. By accounting for a thickness of saw blade 72, cutting speed, stone hardness, and stone size, overheating is avoided during the cutting of stone slab 22.

Exposed or sawn surfaces of portions of stone slab 22 of first and second composite stone panels 80a and 80b can be rough and non-planar after cutting. In applications in which smoother, more planar exposed surfaces are desired, a surface of stone slab 22 can be further planarized and smoothed, thereby forming stone panel 22 with a substantially smooth surface and a substantially uniform thickness. Exposed surfaces of stone slab 22 can be planarized by grinding, polishing, or other suitable process or combination of processes. In an embodiment, a composite stone panel 80 can be placed in a gauging machine to planarize the exposed stone surface. Different tolerances for a thickness and surface planarity of portions of stone slab 22 can be set depending on the final application or end use of the stone panel.

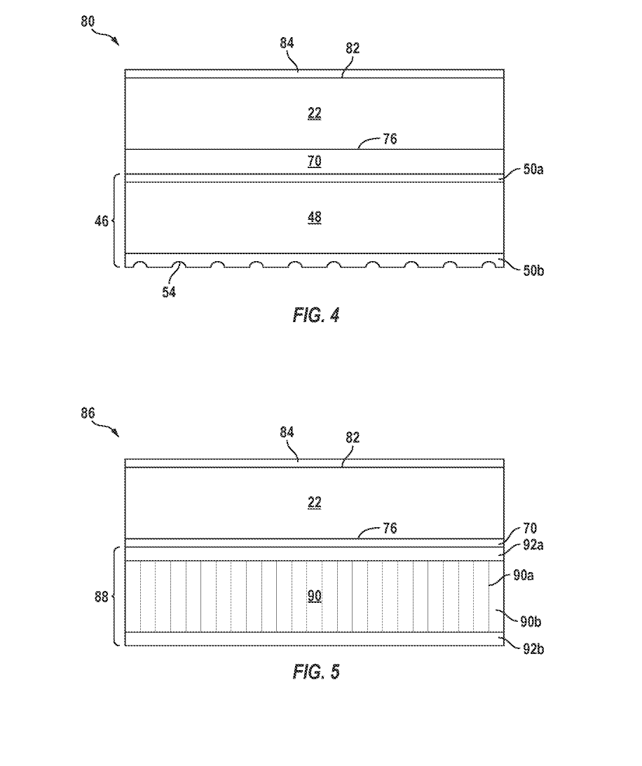

FIG. 4 shows a cross-sectional view of a portion of a single composite stone panel 80 similar to panels 80a and 80b from FIG. 3. After separation of stone slab 22 along separation line 74, an exposed surface or face 82 of stone slab 22 is exposed opposite outer surface 76 and panel backer 46. Exposed surface 82 can be rough, uneven, and non-planar after cutting. In applications in which a smoother, more planar exposed surface 82 is desired, surface 82 of stone slab 22 can be planarized and smoothed, thereby forming stone slab 22 with a substantially uniform thickness. Exposed surface 82 can be planarized by grinding, polishing, or other suitable process. In an embodiment, composite stone panel 80 is placed in a gauging machine to planarize exposed surface 82. Different tolerances for thickness and surface planarity of stone slab 22, as well as composite stone panel 80, can be set depending on the final application or end use of the composite stone panel.

After cutting or planarizing exposed surface 82, a finish or sealant 84 can be applied to exposed surface 82. Many types of stone, and especially more porous types of stone, include naturally occurring holes, voids, and fissures, that can be filled with finish 84 to produce a more planar surface. In an embodiment, finish 84 includes a resin fill. By applying finish 84 to exposed surface 82, dust, dirt, water, contaminants, and other particles or substances can be prevented from undesirably discoloring, dirtying, or wearing stone slab 22. Depending on the nature and type of finish 84, the finish can undergo an optional drying or curing process. For example, a resin fill can be applied to stone slab 22 and then placed on a conveyor and sent through a drying oven to improve a bond between the resin fill and the stone slab. After finish 84 is cured or dried, stone slab 22 and finish 84 can undergo polishing, for example on a polishing machine.

By forming composite stone panel 80 with panel backer 46, composite stone panel 80 can be larger and stronger than previously made panels. As mentioned previously, a CTE of core material 48 can be in a range of about 20-200, while a CTE of stone slab 22 can be in a range of about 5-15, or about 10. A CTE mismatch or difference in CTEs between the stone slab 22 and the core material layer 48 means that during temperature cycling the differences in expansion and contraction will cause stress and strain to develop at an interface between stone slab 22 and core material layer 48. However, stresses developed from the CTE mismatch between stone slab 22 and core material layer 48 can be mitigated by interface layer 50a. When interface layer 50a comprises a metal such as aluminum, the interface layer can have a CTE in a range of about 20-30, or a CTE between the CTEs of stone slab 22 and core material layer 48, which reduces the CTE mismatch and the resulting strain. Additionally, strain generated by CTE mismatch is also born, at least in part, by interface layer 50. Because metal or aluminum interface layer 50a includes a tensile strength greater than a tensile strength of core material layer 48, an overall tensile strength of panel backer 46 and composite stone panel 80 is increased, which in turn allows for composite stone panel 80 to be made with stone slabs 22 of larger sizes.

The additional strength attained by composite stone panel 80 from panel backer 46 allows the composite stone panel 80 to comprise a length greater than 2.4 m (or 8 ft.), a width greater than 1.2 m (or 4 ft.). In another embodiment, composite stone panel 80 can comprise an area greater than, or about, 1.55 m by 3.0 m (or 61 in. by 120 in.). In yet another embodiment, composite stone panel 80 can comprise an area greater than, or about, 1.2 m by 0.6 m (or 48 in. by 24 in.). For any given area of composite stone panel 80, including those referenced above, a thickness of the composite stone panel 80 can be in a range of 0.6-3.0 cm. More specifically, a thickness of composite stone panel 80 can comprise a thickness less than 1.9 cm, less than 1.5 cm, and less than 1.1 cm. In some instances, composite stone panel 80 can comprise a minimum thickness of 0.6 cm, and as such can comprise a thickness in a range of 0.6-1.1 cm, 0.6-1.5 cm, or 0.6-1.9 cm. By forming composite stone panels 80 with panel backers 46, robust composite stone panels can be made in sizes that are greater than what was previously attainable in the prior art with other backers, such as thinner backers. Thinner backers 46 can comprise a thickness less than 1.75 cm, such as a thickness less than 1.5 cm, less than 1.0 cm, and less than 0.5 cm. In each case, backers 46 can comprise a minimum thickness of a bout 0.3 cm so the backers can comprise a thickness in a range of 0.3-0.5 cm, 0.3-1.0 cm, or 0.3-1.5 cm.

The larger size of composite stone panels 80 can provide for applications in which installation is simplified because fewer panels are needed to cover a similar area with stone. Using a smaller number of panels or a single panel to cover an area that would have previously been covered by multiple panels can also provide for a more aesthetic product by reducing a number of joints or seems between panels or stone pieces. Additionally, when used in a shower environment a single composite panel now can cover an entire 1.54 m wide tub surround area with no seams between panels, thereby creating a grout-less and seamless environment. Previously, a 1.54 m seamless surround area could not be provided by a commercially available product when using stone composite panels.

FIG. 5 shows a cross-sectional view of a portion of a single composite stone panel 86 similar to panel 80 from FIG. 4. Panel 86 differs from panel 80 by the inclusion of panel backer 88 rather than panel backer 46. Panel backer 88 comprises core layer 90 and interface layers 92. Core layer 90 comprises structural members 90a that are alternately arranged with respect to, and separated by, spaces 90b. In an embodiment, core layer 90 is organized in a “honeycomb” configuration, although a footprint of structural members 90a and spaces 90b can be formed in any shape or pattern including, without limitation, circles, squares, polygons, lines, crosses, arrows, channels, and angles. Core layer 90 can be made of any suitable metal such as, without limitation, steel, iron, copper, aluminum, or alloys thereof. Core layer 90 can also be made of fiberglass, carbon fiber, plastic, metal, other suitable material, or combination of materials comprising a desirable strength, size to weight ratio, and CTE. In an embodiment, structural members 90a are aluminum. Core layer 90 can comprise a thickness in a range of 3.75 mm to 6.00 mm. Core layer 90 is disposed or “sandwiched” between non-metallic interface layers 92a and 92b such that a first surface of core layer 90 is coupled to or contacts interface layer 92a and a second surface of core layer 90 opposite the first surface is coupled to or contacts interface layer 92b.

Interface layers 92 are similar to interface layers 50 of panel backers 46. Interface layers 92 can be made of any suitable metal such as, without limitation, steel, iron, copper, aluminum, or alloys thereof. Interface layers 92 can also be made of made of a fiberglass, carbon fiber, plastic, other suitable material, or combination of materials comprising desirable strength, size to weight ratio, and CTE. In a particular non-limiting embodiment, when structural members 90a are aluminum, interface layers 92a and 92b comprise fiberglass layers. Interface layers 92a and 92b can include a thickness in a range of about 0.21-0.30 mm (or about 8-12 mils).

Panel backer 88 is formed by attaching or coupling core layer 90 to interface layers 92a and 92b with an adhesive or glue similar to adhesive 70. In an embodiment, the adhesive that attaches core layer 90 to interface layers 92 is an epoxy glue. Panel backers 88 can also be formed with optional dimples similar to dimples 54 to improve adhesion between the panel backer and the adhesive, as described above in relation to composite stone panel 80. Forming panel backer 88 comprising core layer 90 sandwiched between interface layers 92 provides advantages similar to those described above with respect to composite stone panel 80. For example, panel backer 88 increases an overall tensile strength of composite stone panel 86. Additionally, a size of composite stone panel 86 can be greater than a size of stone panels previously known in the art. As represented in FIG. 5, stone slab 22 can comprise a length greater than 2.4 m (or 8 ft.) and a width greater than 1.2 m (or 4 ft.) such that composite stone panel 86 comprises a thickness in a range of 0.5-3.0 cm (or 0.2-1.2 in.). Commonly, composite stone panel 86 can comprise an area of about 1.5 m by 2.4 m (or 60 in. by 96 in.). In other embodiment, composite stone panel 86 can comprise an area of about 1.2 m (or 4 ft.) and a width greater than 0.6 m (or 2 ft.).

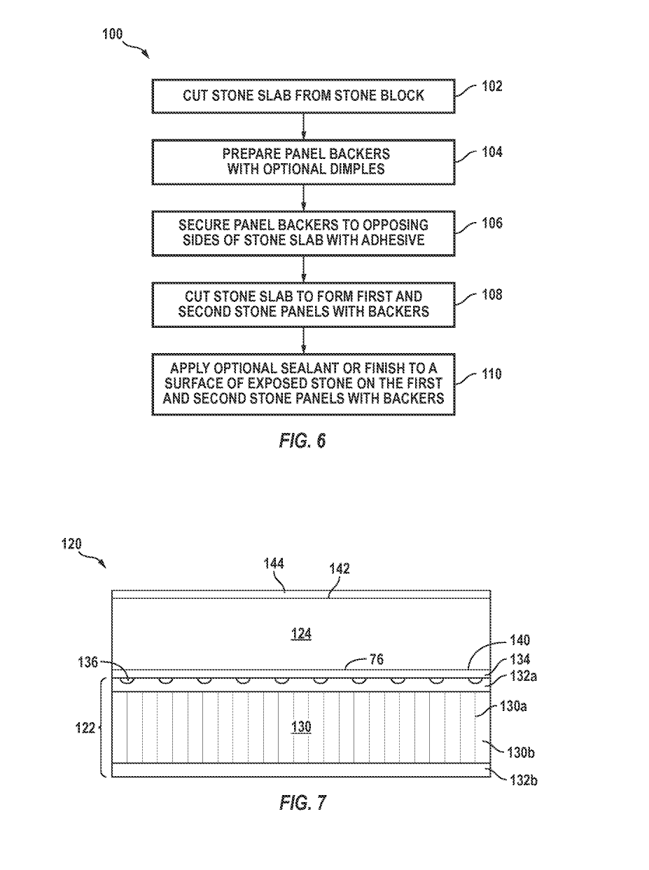

FIG. 6, shows a number of steps for a method 100 of forming a composite stone panel comprising, cutting a stone slab from a stone block (step 102), preparing panel backers with optional dimples (step 104), securing panel backers to opposing sides of the stone slab with adhesive (step 106), cutting the stone of the stone slab to form first and second stone panels with backers (step 108), and applying an optional sealant or finish to a surface of exposed stone on the first and second stone panels with backers (step 110).

FIG. 7 shows a cross-sectional view of a portion of a completed translucent composite stone panel 120 similar to the view of composite stone panel 86 in FIG. 5. The translucent composite stone panel 120 comprises a translucent panel backer 122 and a translucent stone slab or panel 124. Translucent panel 120 can differ from panel 86 by the inclusion of translucent panel backer 122. The translucent panel backer 122 comprises translucent core layer 130 and interface layers 132. The translucent core layer 130 comprises translucent structural members 130a that are alternately arranged with respect to, and separated by, spaces 130b. In an embodiment, translucent core layer 130 is organized in a “honeycomb” configuration in which a footprint of translucent structural members 130a and spaces 130b can be hexagonal in shape. Alternatively, a footprint of translucent structural members 130a and spaces 130b can be formed in any shape or pattern including, without limitation, circles, squares, polygons, lines, crosses, arrows, channels, and angles. Translucent core layer 130 can be made of any suitable material such as, without limitation, fiberglass, carbon fiber, plastic, other suitable material, or combination of materials comprising a desirable strength, size to weight ratio, and CTE. Translucent core layer 130 can comprise a thickness equal to a thickness of translucent panel backer 122 less a thickness of the translucent interface layers 132 and less a thickness of an adhesive, if any, used for bonding the translucent core layer 13 to one translucent panel backers 122. In other words, translucent core layer 130 can comprise a thickness in a range of about 0.3-1.74 cm, 3-6 mm, or 3.75-5 mm, or less than about 1.75 cm, 1.5 cm, 1.0 cm, or 0.5 cm.

Translucent core layer 130 can be disposed or “sandwiched” between translucent interface layers 132a and 132b such that a first surface of translucent core layer 130 is coupled to or contacts translucent interface layer 132a and a second surface of translucent core layer 130 opposite the first surface is coupled to or contacts translucent interface layer 132b.

Translucent interface layers 132 can be made, without limitation, of any suitable translucent material such as fiberglass, carbon fiber, plastic, other suitable material, or combination of materials comprising desirable strength, size to weight ratio, and CTE. The material of translucent interface layers 132 can be the same or different from the material of translucent core layer 130. Interface layers 132a and 132b can include a thickness in a range of about 0.1-2.0 mm or 0.2-0.3 mm (or about 8-12 mils). In a particular non-limiting embodiment, interface layers 132a and 132b can comprise fiberglass layers with a thickness in a range of about 0.2-0.3 mm.

Translucent panel backer 122 is formed by attaching or coupling translucent core layer 130 to translucent interface layers 132a and 132b with an adhesive or glue 134 that can be a one-stage or multi-stage adhesive that cures, dries, or chemically reacts to provide a permanent bond and physical connection between translucent panel backer 122 and translucent stone slab 124. In an embodiment, adhesive 134 is an epoxy glue. The adhesive 134 can be formed as a layer with a thickness in a range of 0.2 mm-1.5 mm. The adhesive 134 that attaches translucent core layer 130 to interface layers 132a and 132b can be an epoxy glue or other adhesive that when cured is translucent and can also be transparent, colorless, or of a color to compliment a color of the translucent stone slab 124 to which it is attached. Translucent panel backers 122 can also be formed with optional dimples 136, similar to dimples 54, to improve adhesion between the translucent panel backer 122 and the adhesive 134, as described above in relation to composite stone panel 80. Forming translucent panel backer 122 comprising translucent core layer 130 sandwiched between translucent interface layers 132 provides advantages similar to those described above with respect to composite stone panel 86. For example, translucent panel backer 122 can increase an overall tensile strength of the translucent composite stone panel 120.

A size of translucent panel backer 122 can comprise a thickness that is less than those previously known in the art, and an area (length times width) that is greater than those previously known in the art. The translucent panel backer 122 can comprise a thickness in a range of about 0.2-1.75 cm, 0.3-1.74 cm, 0.2-1.5 cm, 3-6 mm, or 3.75-5 mm, or less than about 1.75 cm, 1.5 cm, 1.0 cm, or 0.5 cm. The translucent panel backer 122 can comprise a length greater than 1.2 m (or 4 ft.) and a width greater than 0.6 m (or 2 ft.). In some embodiments, translucent composite stone panel 122 can comprise a size of about 1.5 m by 2.4 m (or 60 in. by 96 in.). The translucent panel backer 122 can also comprise a length greater than or about 2.4 m (or 8 ft.) and a width greater than 1.2 m (or 4 ft.). In other embodiments, translucent panel backer 122 can comprise a size greater than or about 0.9 m by 1.5 m (or 3 ft. by 5 ft.). As used in determining sizes of translucent composite stone panel 122, the term “about” can refer to a difference (plus or minus) less than or equal to 20%, 15%, 10% or 5%.

By forming the translucent panel backer 122 as described above, the backer can be rigid, strong, and lightweight, which provides the advantage of creating a backer for lighter and larger translucent composite stone panels comprising thinner stone portions. Translucent panel backers 122 can be placed on opposing sides of a translucent stone panel before the translucent stone panel is cut into the translucent stone panel 124 in a process similar, or identical, to that discussed above with respect to FIG. 3.

As discussed above with respect to the exposed surface 82 and the finish or sealant 84 of composite stone panel 86 in FIG. 5, the translucent composite stone panel 120 can also include planarizing and polishing of exposed surface 142, a finish or sealant 144 can be applied to exposed surface 142. Many types of stone, and especially more porous types of stone, include naturally occurring holes, voids, and fissures, that can be filled with finish 144 to produce a more planar surface. In an embodiment, finish 144 includes one or more resin fills. By applying finish 144 to exposed surface 142, dust, dirt, water, contaminants, and other particles or substances can be prevented from undesirably discoloring, dirtying, or wearing translucent stone slabs 124. Depending on the nature and type of finish 144, the finish can undergo an optional drying or curing process. For example, a resin fill can be applied to translucent stone slabs 124 and then placed on a conveyor and sent through a drying oven to improve a bond between the resin fill and the stone slab. After finish 144 is cured or dried, translucent stone slabs 124 and finish 144 can undergo polishing or additional polishing on a polishing machine.

Stone used for the formation of translucent stone slab or panel 124 can comprise onyx, travertine, alabaster, marble, or other translucent material. While the following discussion centers on the use of onyx, the advantages described with respect to onyx are also applicable to travertine and to other translucent types of stone.

Onyx has been recognized and used in architectural applications as a translucent stone, and as such has been used in lighting applications, for display, an in various decorative applications, such as in high-end bars. However, the use of onyx, like other translucent stone, has been problematic. Onyx is more fragile than other non-translucent stone, like granite, which often leads to the onyx being broken during installation. To prevent onyx from being broken or damaged during installation, onyx has been combined with other materials, substrates, or backers, such as PVC, glass, or tempered glass, in an attempt to increase strength and reduce breakage. The onyx has been held together with the supporting substrate or backer by mechanical attachments, using supports or channels at an edge of the stone and backer, or with an adhesive, such as transparent epoxy. In some cases the stone has been sandwiched between multiple layers of supporting material.

As such, the cost per square foot of installed onyx is much higher than a cost of the stone itself because of the additional time and expense of removing broken or cracked stone that is damaged during installation. As a non-limiting example, at the time of the writing of this application, a typical cost per square foot of onyx including a backer of PVC, glass, or other material, can be in a range of about 25-35 dollars. Accounting for rework and damaged material, typical costs for installed onyx are typically in a range of about 80-100 dollars per square foot. Thus, the difficulties of working with onyx can result in an installed price of onyx that is in a range of about 2-4 times more than a cost of material for the stone with a PVC backer. Thus, the use of onyx for many decorative applications can be cost prohibitive do its breakability and associated high cost. Additionally, a size of onyx panels can be limited, and a supporting framework for coupling the onyx panels can cause separation and offset between the panels of onyx.

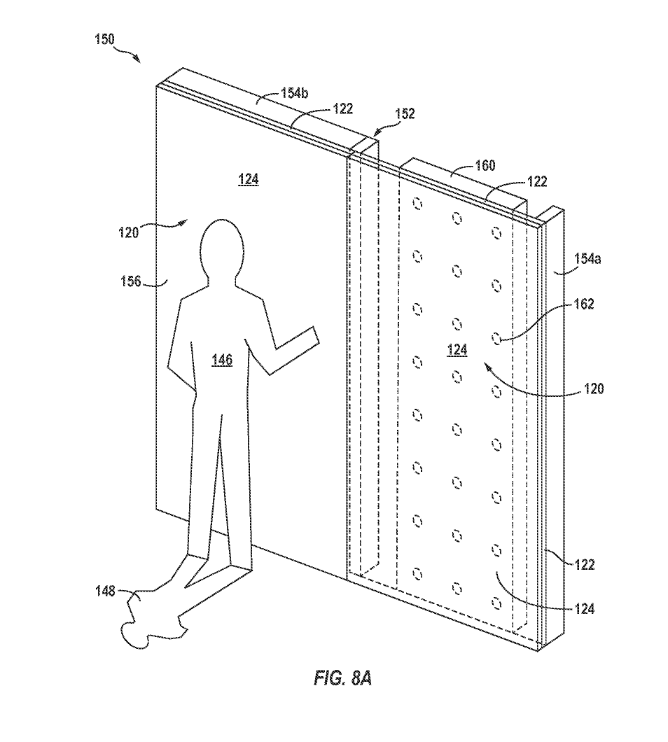

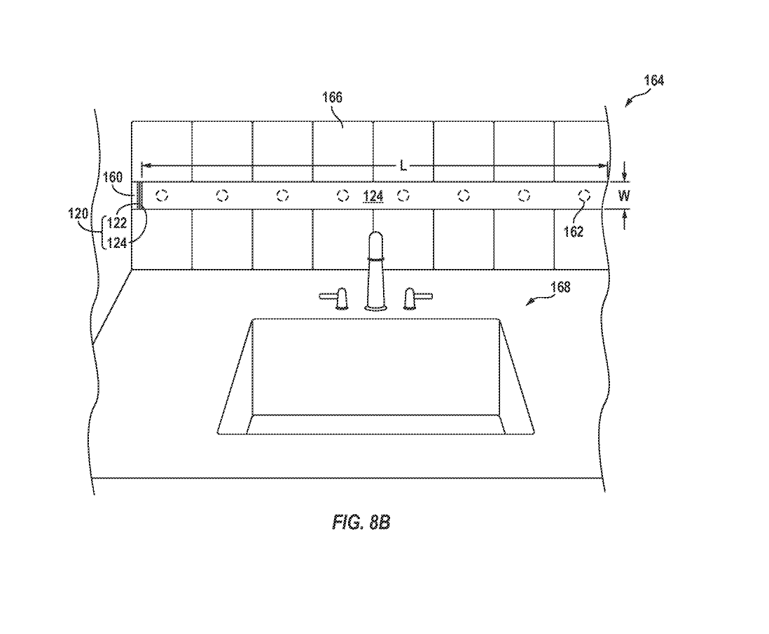

However, at the time of writing of this application, a cost of material for the translucent honeycomb stone backer panel disclosed herein can be in a range of about two to four dollars per square foot, or about three dollars a square foot. Thus, by using the system and method described herein to create a translucent stone panel comprising a translucent backer, a cost of the stone per square foot can be much lower, while also reducing a cost of breakage and reducing a difficulty of installation. At the time of writing of the present application, the price per square foot of installed onyx can be in a range of about 40-50 dollars per square foot, or about half the cost of conventionally installed onyx with conventional supports systems, backers, or substrates, such as PVC or glass backers. In addition to costing much less, a durability of the onyx translucent stone slab 124 is also increased due to the translucent panel backer 122. By coupling the onyx stone slab 124 to a translucent panel backer 122, an improved translucent composite onyx panel 120 can be produced. Both durability and size of the translucent composite onyx panel 120 can be increased. For example, an available size of onyx translucent stone slabs 124 can include a length about or greater than 1.2 m (or 4 ft.) and a width about or greater than 0.6 m (or 2 ft.). In some embodiments, the available size of the onyx translucent stone slabs 124 can be increased to about or greater than 1.5 m by 2.4 m (or 60 in. by 96 in.). The onyx translucent stone slabs 124 can also comprise a length greater than or about 2.4 m (or 8 ft.) and a width greater than 1.2 m (or 4 ft.). In other embodiments, onyx translucent stone slabs 124 can comprise a size greater than or about 0.9 m by 1.5 m (or 3 ft. by 5 ft.). A thickness of the onyx translucent stone slabs 124 can be in a range of about 0.2-3.0 cm or 0.2-1.5 cm, or less than 2.5 cm, less than 1.9 cm, less than 1.5 cm, and less than 1.1 cm. Additionally, as described in greater detail below with respect to FIGS. 8A and 8B, installation and display or presentation of the onyx translucent stone slabs 124 is also improved. As used in determining sizes of translucent composite stone panel 122, the term “about” can refer to a difference (plus or minus) less than or equal to 20%, 15%, 10% or 5%.

Travertine, like onyx, has also been recognized as a translucent stone and has been used in various architectural applications. However, travertine is more fragile than other non-translucent stone, like granite, which limits a size and thickness of the travertine shipped and used, as well as increasing a frequency of breakage of travertine during installation. By coupling a travertine stone slab 124 to a translucent panel backer 122, an improved translucent composite travertine panel 120 can be produced. Both durability and size of the translucent composite travertine panel 120 can be increased. For example, an available size of travertine translucent stone slabs 124 can include a length about or greater than 1.2 m (or 4 ft.) and a width about or greater than 0.6 m (or 2 ft.). In some embodiments, the available size of the travertine translucent stone slabs 124 can be increased to about or greater than 1.5 m by 2.4 m (or 60 in. by 96 in.). The travertine translucent stone slabs 124 can also comprise a length greater than or about 2.4 m (or 8 ft.) and a width greater than 1.2 m (or 4 ft.). In other embodiments, travertine translucent stone slabs 124 can comprise a size greater than or about 0.9 m by 1.5 m (or 3 ft. by 5 ft.). A thickness of the travertine translucent stone slabs 124 can be in a range of about 0.2-3.0 cm or 0.2-1.5 cm, or less than 2.5 cm, less than 1.9 cm, less than 1.5 cm, and less than 1.1 cm. Additionally, as described in greater detail below with respect to FIGS. 8A and 8B, installation and display or presentation of the travertine translucent stone slabs 124 is also improved. As used in determining sizes of translucent composite stone panel 122, the term “about” can refer to a difference (plus or minus) less than or equal to 20%, 15%, 10% or 5%.

Marble, like onyx and travertine, is softer than granite, and as such has conventionally required greater thicknesses to prevent breaking and cracking. The greater thicknesses used for marble to prevent or limit cracking have also limited passage of light, which has led marble to be considered a non-translucent material. A typical range of thicknesses for marble, such as white marble, could be 2-3 cm for a conventional interior application. The 2-3 cm thickness of marble (roughly one inch plus or minus one-quarter inch) is too thick to allow for the passage of light, and as such has not been conventionally considered a translucent material. However, by coupling a thin marble stone slab 124 to a translucent panel backer 122, a translucent composite marble panel 120 can be produced. By coupling a marble stone slab 124 to a translucent panel backer 122, an improved translucent composite marble panel 120 can be produced. Both durability and size of the translucent composite marble panel 120 can be increased. For example, an available size of marble translucent stone slabs 124 can include a length about or greater than 1.2 m (or 4 ft.) and a width about or greater than 0.6 m (or 2 ft.). In some embodiments, the available size of the marble translucent stone slabs 124 can be increased to about or greater than 1.5 m by 2.4 m (or 60 in. by 96 in.). The marble translucent stone slabs 124 can also comprise a length greater than or about 2.4 m (or 8 ft.) and a width greater than 1.2 m (or 4 ft.). In other embodiments, marble translucent stone slabs 124 can comprise a size greater than or about 0.9 m by 1.5 m (or 3 ft. by 5 ft.). A thickness of the marble translucent stone slabs 124 can be in a range of about 0.2-3.0 cm or 0.2-1.5 cm, or less than 2.5 cm, less than 1.9 cm, less than 1.5 cm, and less than 1.1 cm. Additionally, as described in greater detail below with respect to FIGS. 8A and 8B, installation and display or presentation of the marble translucent stone slabs 124 is also improved. As used in determining sizes of translucent composite stone panel 122, the term “about” can refer to a difference (plus or minus) less than or equal to 20%, 15%, 10% or 5%.

After forming the translucent panel backer 122, or at a same time as forming the translucent panel backer 122, translucent composite stone panel 120 can be formed by attaching, joining, or bonding one or more translucent panel backers 122 to a translucent stone slab 124 with an adhesive 138, which may be similar or identical to adhesive 134. Adhesive 138 can also be transparent, colorless, or of a color to compliment a color of the translucent stone slab 124 to which it is attached. Similar to the process of forming composite stone panels 80 in FIG. 3, one or more than one translucent panel packers 122 can be attached to the translucent stone slab 124, such as opposing outer surfaces 140 of the translucent stone slab 124.

By forming translucent composite stone panel 120 as described above, a size of translucent composite stone panel 120 can comprise an area (length times width) that is greater, and a thickness that is less than, that of translucent stone panels previously known in the art. As represented in FIGS. 7 and 8, the translucent composite stone panels 120 can comprise a thickness in a range of about of 0.5-3.5 cm, or less than about 2.5 cm, 2.3 cm, 1.9 cm, 1.5 cm, or 1.1 cm. As represented in FIGS. 7 and 8, the translucent composite stone panels 120 can comprise a length greater than or about 2.4 m (or 8 ft.) and a width greater than 1.2 m (or 4 ft.). Translucent composite stone panels 120 can also comprise a length greater than or about 1.2 m (or 4 ft.) and a width greater than 0.6 m (or 2 ft.). In some embodiments, translucent composite stone panel 120 can comprise a size greater than or about 1.5 m by 2.4 m (or 60 in. by 96 in.). In yet other embodiments, translucent composite stone panel 120 can comprise a size of about 0.9 m by 1.5 m (or 3 ft. by 5 ft.). As used in determining sizes of translucent composite stone panel 120, the term “about” can refer to a difference (plus or minus) less than or equal to 20%, 15%, 10% or 5%.

FIG. 8A shows an embodiment in which a number of large translucent composite stone panels 120 are coupled together. The large translucent composite stone panels 120, as indicated above, can comprise a length greater than 1.2 m (or 4 ft.) and a width greater than 0.6 m (or 2 ft.) as well as a size of about 1.5 m by 2.4 m (or 60 in. by 96 in.). A person 146 is shown in front of one of a translucent composite stone panel 122 to show a scale of the translucent composite stone panel. A shadow 148 of the person 146 is also shown to indicate the translucent composite stone panel 120 can be illuminated.

The large translucent composite stone panels 120 can be coupled together as part of an architectural feature 150, such as a decorative illuminated wall, a window, a ceiling or panel for a residential of commercial application including for a bar, office building, conference room, hotel lobby, elevator, display, fireplace, bathroom, or other application. The large translucent composite stone panels 120 can be mounted next to each other using a translucent frame or support structure 152. Translucent frame 152 can include any number of support members 154, including vertical support members 154a and horizontal support members 154b. The translucent frame 152 can be completely mounted to a rear surface of the translucent composite stone panels 120, such as translucent panel backers 122. As a result, translucent stone slabs 124 form, or can be arranged to include, a front visible or exposed surface 156 of the architectural feature 150 that is free from obstructions or visual distractions, and is entirely comprised of translucent stone slabs 124.

In some embodiments, support members 154 can be formed of one or more strong, rigid, and transparent materials such as plastics including polymethyl methacrylate (acrylic-glass or Plexiglas), polyvinyl chloride (PVC), vinyl nitrile (VN), acrylonitrile butadiene styrene (ABS), polycarbonate, PE, polyethylene terephthalate (PET), or other similar material. Support members 154 can be formed as elongate members or studs comprising a cross-sectional shape 158 that can be rectangular, square, angled, T-shaped, I-shaped, U-shaped, L-shaped, or of any other shape. FIG. 8a illustrates a non-limiting example in which the cross-sectional shape 158 can be a rectangular shape that is similar or identical to that of conventional wood or metal studs, such as two-by-four or two-by-six studs. Support members 154 can be coupled, directly or indirectly, to potions of one or more translucent composite stone panels 120.

As shown in a central portion of FIG. 8A, a joint along vertical edges of two or more translucent composite stone panels 120 can be aligned along a height of a vertical support member 154a. For example, a first portion (such as a first half) of the vertical support member 154a can be disposed behind and coupled to a backside of a portion of a first translucent composite stone panel 120. Similarly, a second portion (such as a second half) of the vertical support member 154a can be disposed behind and coupled to a backside of a portion of a second translucent composite stone panel 120. Furthermore, by forming support members 154 of translucent material, light is allowed to pass through the support members 154 without interfering with the passage of light to noticeably or significantly changing illumination of the translucent stone panels. As such, a plurality of translucent composite stone panels 120 can be joined without obscuring light and making shadows or dark spots on architectural feature 150.

Forming translucent composite stone panel 120 with translucent panel backer 122 provides a number of advantages with respect to practices and structures as known in the prior art. A first method and structure previously practiced in the art includes forming a translucent stone panel comprising a first backer type comprising a solid, planar, uniform, laminar sheet formed as a backer comprising PVC, Acrylic, Plexiglas, or other similar material coupled to a translucent stone slab, which for convenience are referred to herein as PVC backers. While PVC backers add some strength to the stone panels, the PVC backers and resulting composite stone panels tend to flex and curl, and are particularly susceptible to flexing and curling that results from temperature changes and thermal expansion and contraction of the composite stone panel.

While some small PVC backed composite stone panels have had limited success in interior applications where there is not a lot of temperature fluctuation and thermal expansion or contraction, mitigating measures can still be required. For example, composite stone panels comprising PVC backers often require one or more reinforcing members, such as tracks or channels, that are disposed along panel edges and hold opposing sides of the panel in straight lines to prevent bowing of the panel. By holding opposing sides of panel edges, the reinforcing members of the PVC backed composite stone panel do not include a front visible or exposed surface 156 that is free from, or uninterrupted by, obstructions or visual distractions. Instead, composite stone panels comprising PVC backers when used adjacent one another present an stone face that is interrupted with reinforcing members, which can detract from a positive aesthetic of the architectural feature in which the composite stone panels are used.

A second method and structure previously practiced in the art includes forming a translucent stone panel comprising a glass backer or a slab of translucent stone disposed or sandwiched between two plates of glass. Examples of translucent stone panels comprising glass reinforcement produced by the StonePly company are available at http://www.stone-panel.com/info_applications/stoneply-translucent-stone-panels/. However, a disadvantage of reinforcing a stone slab with glass is that the stone and glass cannot be cut together or at a same time. As a result, precise dimensions for the final application of the composite panel are needed before installation. The stone slab and the glass used in forming the composite stone panel needs to be pre-ordered and separately cut to size before shipping the composite stone panel to the installation site. As a result, installers of a glass composite stone panel do not have the flexibility of on-site adjustments or the flexibility of on-site customization. To the contrary, translucent composite stone panel stone panels 120 can be cut with both the translucent panel backer 122 and the translucent stone slabs 134 being cut at a same time. As such, installers of translucent composite stone panel 120 do have the flexibility of on-site adjustments adjust a size, shape, or dimension of the translucent composite stone panel 120 to accommodate any differences in anticipated and actual on site sizing and positioning. As a non-limiting example, translucent composite stone panel 120 can be installed using a fest tool cutting system, which allows for on-site adjustment and greater flexibility in installation. Using the fest tool cutting system together with translucent composite stone panel 120 can allow for special or custom patterns being assembled on site, such as a herring bone pattern, a 4-cut pattern, or any other pattern.

A third method and structure previously practiced in the art includes translucent stone pieces that were light and self-supported without additional reinforcement. As such, self-supporting pieces of translucent stone were small and thick, and did not include dimensions greater than or equal to 1.2 m (or 4 ft.) by 0.6 m (or 2 ft.) by 0.2-3.0 cm, or dimensions greater than or equal to about 1.5 m by 2.4 m (or 60 in. by 96 in.) by 0.2-3.0 cm. Larger translucent stone slabs or panels were subject to excessive breakage, which in turn increased cost and decreased desirability.

A fourth method and structure previously practiced in the art includes forming a composite stone panel comprising a translucent stone panel with an opaque reinforcing backer or other opaque material disposed between the translucent stone and the reinforcing backer so that the reinforcing backer would not be seen. As recited in U.S. Pat. No. 3,950,202 to Hodges (hereinafter “Hodges”), stone veneers comprising a slab of stone and a layer of supporting stratum material could be made using a slab of stone that is translucent or even semi-translucent, such as onyx. Hodges states that when a translucent or semi-translucent stone is used it may be necessary to apply a coloring material or an opaque material between the stone and the stratum supporting material so that completed stone veneers have been formed there is no visual detraction from their appearance because of an ability to see or distinguish the form of the honey comb or other supporting stratum material through the veneered stone face. See Hodges, col. 5, lines 55-68.

FIG. 8A further shows that a lighting unit 160 can be disposed adjacent, coupled to, or both, a rear portion of the translucent composite stone panel 122, opposite the translucent stone slab 124. Lighting unit can comprise a plurality of lights 162, such as electric lights, LEDs, fluorescent lights, halogen lights, as well as bioluminescent lights or any other light emitting or light producing object. Lighting unit 160 can include any number of lights 162 that can be arranged linearly, geometrically, in a grid, as an array, stochastically, or any other way. A color, intensity, and distribution of light 162 can vary according to the configuration, design, and application of architectural feature 150. In some embodiments, the color intensity, and distribution of light 162 will vary according to a thickness and type of translucent stone slabs 124, according to ambient conditions such as ambient lighting and time of day, or both. Lighting unit 160 can be a geometric housing such as a rectangle as illustrated in FIG. 8A. Lighting unit 160 can also be a tube, rope, frame, or other suitable structure for providing any required power to lights 162 as well as for maintaining a desired orientation or distribution of lights 162 and transmitting light through translucent composite stone panel 120. As a non-limiting example, lighting unit 160 can be an LED backer comprising silicone.

FIG. 8B shows another non-limiting example of an elongated architectural feature 164 comprising an elongated translucent composite stone panel 120 that is formed as part of a decorative band or inlay with tile 166 around or near sink and counter 168. The elongated translucent composite stone panel 120 can comprise any of the dimensions discussed above, including without limitation a length L greater than or equal to 1.2 m, a width W greater than 2 cm or in a range of about 2-60 cm, and a thickness in a range of 0.6-3.0 cm, wherein the thickness can match a thickness of conventional tile 166 or other material adjacent the elongated translucent composite stone panel 120 so that the top or exposed surface of elongated translucent composite stone panel 120 can be coplanar with tile 166. As such, the elongated translucent composite stone panel 120 can be set next to, and integrated into, designs and patterns that incorporate both conventional tile and translucent stone panels. Translucent composite stone panel 120 can be integrated as part of architectural features that are around sink and counters 168, walls, floors, or other features, as disclosed herein. In some embodiments, translucent composite stone panel 120 can be cut to size on-site for on-site customization, rather than having each piece or portion of translucent composite stone panel 120 being prefabricated or made at a manufacturing location prior to shipment to the installations site. In some embodiments, on-site customization can be accomplished using a Festool cutting system or other suitable system.

As such, a method of forming an elongated architectural feature 164 or installing an elongated translucent composite stone panel 120 can comprise transporting a first translucent composite stone panel to an installation site, cutting the translucent stone slab and the translucent panel backer of the first translucent composite stone panel at a same time to change a dimension of the first translucent composite stone panel to conform to a dimension of the installation site. Cutting or sizing portions of elongated translucent composite stone panel 120 can be done to form an architectural feature such as architectural features 150 and 164 by that includes patterns or arrangements of portions of translucent composite stone panel 120, such as herring bone patterns, four cut patterns, or other suitable patterns as known in the art.

Elongated architectural feature 164 can optionally comprise a lighting unit 160 comprising built-in lights 162, as described above with respect to FIG. 8A. Lighting unit 160 can comprise silicone, and can also be made with a thin thickness such that a translucent composite stone panel 120 can be can be set next to, and integrated into, designs and patterns that incorporate both conventional tile or materials of conventional thicknesses and pieces or portions of translucent stone panels 120.

In the foregoing specification, various embodiments have been described. It will, however, be evident that various modifications and changes may be made thereto without departing from the broader spirit and scope set forth in the appended claims. The specification and drawings are, accordingly, to be regarded in an illustrative sense rather than a restrictive sense.

What is claimed is:

1. A translucent composite stone panel, comprising:
a translucent stone slab of onyx or travertine comprising a length greater than or equal to 1.2 meters (m), a width greater than or equal to 0.6 m, and a thickness in a range of 0.2-1.5 centimeters (cm); and
a translucent honeycomb panel backer comprising a length greater than or equal to 1.2 m, a width greater than or equal to 0.6 m, a thickness in a range of 0.2-1.5 cm that is coupled to the translucent stone slab.

2. The translucent composite stone panel of claim 1, wherein:
the translucent stone slab of onyx or travertine comprises a length greater than or equal to 2.4 m and a width greater than or equal to 1.2 m; and
the translucent honeycomb panel backer comprises a length greater than or equal to 2.4 m and a width greater than or equal to 1.2 m.

3. The translucent composite stone panel of claim 1, further comprising a lighting unit coupled to the translucent panel backer to illuminate the translucent stone slab.

4. The translucent composite stone panel of claim 3, wherein the translucent honeycomb panel backer further comprises:
a fiberglass or plastic translucent core layer comprising structural members of the core layer; and
first and second fiberglass or plastic translucent interface layers disposed on opposing sides of the translucent core layer, wherein the first and second fiberglass or plastic translucent interface layers comprise a thickness in a range of 0.2-0.3 millimeters (mm).

5. A plurality of the translucent composite stone panels of claim 3 formed as an architectural feature, the architectural feature further comprising a translucent frame coupled to the translucent panel backers and disposed opposite the translucent stone slabs without a track support and without covering any portion of the translucent stone slabs.

6. The translucent composite stone panel of claim 5, wherein a translucent frame comprises support members made of acrylic-glass or polyvinylchloride (PVC).

7. The translucent composite stone panel of claim 1, wherein the translucent composite stone panel is formed without a glass backer and without a solid polyvinylchloride (PVC) backer.

8. A translucent composite stone panel, comprising:
a translucent stone slab of onyx, travertine, or marble comprising a length greater than or equal to 1.2 meters (m) and a width greater than or equal to 0.6 m;
a translucent honeycomb panel backer coupled to the translucent stone slab; and
wherein the composite stone panel comprises a thickness in a range of 0.2-4.0 centimeters (cm).

9. The translucent composite stone panel of claim 8, wherein the translucent stone slab of onyx, travertine, or marble comprises a length greater than or equal to 2.4 m and a width greater than or equal to 1.2 m.

10. The translucent composite stone panel of claim 8, wherein:
the translucent stone slab comprises a thickness in a range of 0.2-2.0 cm; and
the translucent honeycomb panel backer comprises a thickness in a range of 0.2-2.0 cm, wherein the translucent honeycomb panel backer further comprises:
a fiberglass or plastic translucent core layer comprising structural members of the core layer, and
first and second fiberglass or plastic translucent interface layers disposed on opposing sides of the translucent core layer, wherein the first and second fiberglass or plastic translucent interface layers comprise a thickness in a range of 0.2-0.3 millimeters (mm).

11. The translucent composite stone panel of claim 10, further comprising a lighting unit coupled to the translucent panel backer to illuminate the translucent stone slab.

12. A plurality of the translucent composite stone panels of claim 10 formed as an architectural feature, the architectural feature further comprising a translucent frame coupled to the translucent panel backers and disposed opposite the translucent stone slabs without a track support and without covering any portion of the translucent stone slabs exposed with respect to the translucent panel backer.

13. The translucent composite stone panel of claim 12, wherein a translucent frame comprises support members made of acrylic-glass or polyvinylchloride (PVC).

14. The translucent composite stone panel of claim 8, wherein the translucent composite stone panel is formed without a glass backer and without a solid polyvinylchloride (PVC) backer.

15. A method of making translucent composite stone panels, comprising:
providing a translucent stone slab of onyx or travertine comprising a length greater than or equal to 1.2 meters (m) and a width greater than or equal to 0.6 m;
attaching first and second translucent panel backers to first and second opposing surfaces of the translucent stone slab; and
forming first and second translucent composite stone panels by cutting the translucent stone slab between the first and second translucent panel backers.

16. The method of claim 15, further comprising:
providing the translucent stone slab with a length greater than 2.4 m, a width greater than 1.2 m, and thickness in a range of 0.2-1.5 centimeters (cm); and
forming the first and second translucent composite stone panels comprising a thickness in a range of 0.4-3.0 cm.

17. The method of claim 16, wherein forming each of the first and second translucent panel backers further comprises:
providing a fiberglass or plastic translucent core layer comprising structural members of the core layer; and
coupling first and second fiberglass or plastic translucent interface layers on opposing sides of the translucent core layer, wherein the first and second fiberglass or plastic translucent interface layers comprise a thickness in a range of 0.2-0.3 millimeters (mm).

18. The method of claim 19, further comprising forming an architectural feature comprising:
forming a translucent frame comprising support members made of acrylic-glass or polyvinylchloride (PVC);
coupling the translucent panel backer to the translucent frame with the translucent panel backer disposed opposite the translucent stone slab without a track support and without covering any portion of the translucent stone slab exposed from the translucent panel backer; and
forming the translucent composite stone panel without a glass backer and without a solid PVC backer.

19. The method of claim 18, further comprising illuminating the translucent stone slab with a lighting unit coupled to the translucent panel backer.

20. A method of installing the first translucent composite stone panel of claim 15, comprising:
transporting the first translucent composite stone panel to an installation site;
cutting the translucent stone slab and the translucent panel backer of the first translucent composite stone panel at a same time to change a dimension of the first translucent composite stone panel to conform to a dimension of the installation site.
